(19) United States
(12) Patent Application Publication
(10) Pub. No.: US 2005/0269829 A1
(43) Pub. Date: Dec. 8, 2005

(54) Dual function under-hood liner

(76) Inventors: Oivind Nilsrud, Skara (SE); Tommy van den Berg, Gotene (SE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/861,894

(22) Filed: Jun. 4, 2004

(51) Int. Cl. B60J 7/00

(52) U.S. Cl. 296/39.3

(57) ABSTRACT

A liner for the underside of a vehicle hood is provided including a sound reducing structure and an energy absorbing structure. The sound reducing structure may reduce noise generated by the engine and any auxiliary under-hood components. The energy absorbing structure may absorb at least a portion of the energy of a pedestrian striking the hood of the vehicle.

### FIELD OF THE INVENTION

The present invention generally relates to a sound reducing liner for the underside of the hood of a vehicle, and more particularly to a liner for the underside of the hood of a vehicle that provides reduction of engine noise and provides energy absorption in the event of an accident in which a pedestrian contacts the hood of the vehicle.

### BACKGROUND OF THE INVENTION

With the ever-increasing number of motor vehicles on the road, concern regarding pedestrian safety is an often raised issue. Even at relatively low speeds, an accident between a motor vehicle and a pedestrian can result in a great deal of injury to the pedestrian. One source of injury in an accident between a motor vehicle and a pedestrian is the impact of the pedestrian against the hood of the motor vehicle. Often, impact between the pedestrian and the vehicle hood may not be the primary impact. For example, during a collision between a motor vehicle and a pedestrian, the front bumper or a fender may strike the pedestrian first. The force of the impact may cause the torso or head of the pedestrian to strike the hood and/or upper fenders of the motor vehicle. Impacts of this nature may cause serious injury.

Modern vehicle design has, in some ways, exacerbated the problem of pedestrian impacts with a vehicle hood. In attempts to improve vehicle efficiency and aerodynamics, as well as to meet popular styling demands, vehicles are being designed with lower front ends and more compact engine compartments having less free space. As a result there is often only a small amount of clearance between the hood of the vehicle and the engine or auxiliary under-hood components. As a result, in the event of a collision with a pedestrian, the vehicle hood may only deflect a small amount before contacting the engine or an under-hood component. If the under-hood component is unyielding or presents a hard corner, an impact in which a pedestrian strikes the under-hood component through the hood may produce severe injury to the pedestrian.

U.S. Pat. No. 5,744,763, to Iwasa et al., describes a sound proofing material that may be applied to the underside of a vehicle hood. The material has a generally sheet-like form and includes a pulverized rubber layer containing rubber grains of various kinds of material, various sizes and various shapes and covering layers, or housing, which cover the pulverized rubber layer. In the disclosed soundproofing structure, a plurality of air pockets are defined between a first covering layer and the hood of a vehicle. The second covering layer, facing the noise source, includes a plurality of through holes.

U.S. Pat. No. 4,646,864, to Racchi, discloses an engine compartment sound and water shield pad. The disclosed shield pad is a one-piece structure formed as a substantially self-supporting sheet, which is configured to be supported by, or suspended from, the underside of a vehicle hood. The pad includes a material providing sound dampening properties and includes an integrally formed drain tray portion. The disclosed shield pad may be used to direct water entering through ventilators or air passages in the hood away from the vehicle engine and electrical components.

While both the Iwasa, et al. and Racchi references are directed at sound dampening, neither addressed absorbing energy from an impact with a pedestrian.

U.S. Pat. No. 4,359,120, to Schmidt et al. and assigned to Daimler-Benz, discloses a vehicle with front body sections that are adapted to yield to impact forces of a pedestrian striking from the front or above. The hood of the vehicle, and/or body parts surrounding the hood, is supported on reinforcing members by way of permanently deformable deformation members. The permanently deformable deformation members are disclosed as profiled energy absorbing members, such as inwardly curved border zones, at the boundaries of the hood and vehicle fenders. Under an impact, such as a pedestrian striking the hood and/or surrounding body parts, the collision forces may be uniformly distributed all over the zone.

EP 1 078 826 B1, assigned to Ford Global Technologies, discloses a vehicle safety device that increases the clearance between a vehicle hood and engine upon collision with a pedestrian. The hood of the vehicle is hinged at its leading edge and releasably hinged at its trailing edge. Upon impact with a pedestrian the leading edge of the hood is lowered to cushion the pedestrian during the impact, and the trailing edge of the hood raises upwardly.

WO 00/30904, assigned to Volkswagen, discloses edge parts which form an upper edge area on the front end of a vehicle. The edge parts function as energy absorbing elements in the event of a pedestrian impact. The edge parts are straightened out in a collision with a pedestrian and allow the hood to be independently configured as a further surface deformation element.

JP 10-218022 A2, assigned to Mitsubishi Motor Corp., is directed at a car body panel arranged between a hood panel and front panel of the car. The body panel has an inner panel that is an energy absorbing member lined to an outer panel. A support stay is included which is said to contain a “buckling deformation” function. The plastic deformation of the body panel and the buckling deformation of the support stay allow energy from an impact with a pedestrian to be absorbed.

JP 58-221773 A2, assigned to Nissan Motor Co., is directed at an assembly for preventing pedestrian casualties in the event of a collision with a car and tumbling against the hood of the vehicle. The assembly includes a guide member that supports the hood. When a downward and rearward load is applied to the hood by a pedestrian colliding against the car, the assembly will allow a leading edge of the hood to move downward and rearward. At the same time, a rear section of the hood may be guided obliquely upward.

What is needed, therefore, is an energy absorbing structure that may be applied to the underside of the vehicle hood, preferably including with a sound reducing liner, to reduce hood deflection and/or absorb impact energy upon encountering a pedestrian.

### SUMMARY OF THE INVENTION

According to one aspect, the present invention provides a liner for the underside of a vehicle hood in which the liner includes a sound reducing structure and an energy absorbing structure.

According to another aspect, the present invention provides a liner for the underside of a vehicle hood in which the liner includes a sound reducing material and a formed rib structure. The formed rib structure may be at least partially disposed in the sound reducing material.

According to still another aspect, the present invention provides a liner for a vehicle hood including a fibrous body which includes an energy absorbing structure.

According to still another aspect, the present invention provides a liner for a vehicle hood including a sound reducing structure and an energy absorbing structure wherein the energy is absorbed by the bending of the structure.

According to a still further aspect, the present invention provides a liner for a vehicle hood including a sound reducing structure, and an energy absorbing structure wherein the energy is absorbed by the buckling or crushing of the structure.

### BRIEF DESCRIPTION OF THE DRAWINGS

Features and advantages of the present invention are set forth by way of description of various embodiments consistent with the present invention, which description should be considered in conjunction with the accompanying drawings, in which like parts are indicated with like numerals having sequential alphabetic characters appended to indicate varying embodiments of such parts, and wherein:

FIG. 1 is a schematic illustration of an under-hood liner for a vehicle including an energy absorbing structure according to the present invention;

FIG. 2 is a sectional view of the under-hood liner of FIG. 1 taken along line A-A;

FIG. 3 is a perspective view of one embodiment of an energy absorbing structure suitable for use with the present invention;

FIG. 4 illustrates another embodiment of an energy absorbing structure suitable for use with the present invention;

FIG. 5 shows yet another embodiment of an energy absorbing structure suitable for use with the present invention; and

FIG. 6 shows still a further embodiment of an energy absorbing structure suitable for use with the present invention.

### DETAILED DESCRIPTION OF THE INVENTION

As noted above, the invention herein is directed at an under-hood liner that provides sound reduction and energy absorption. The under-hood liner includes an energy absorbing structure which may be generally configured to absorb the energy of a pedestrian impacting the hood of the vehicle. Particularly, an energy absorbing structure may be provided in combination with a sound reducing under-hood liner. The energy absorbing structure may be configured to cushion the impact of a pedestrian striking the hood of the vehicle. As such, the under-hood liner may reduce the likelihood that a pedestrian striking the hood of the vehicle will impact a hard or sharp under-hood component, such as a portion of the engine, through the hood, and/or may reduce the severity of such impacts.

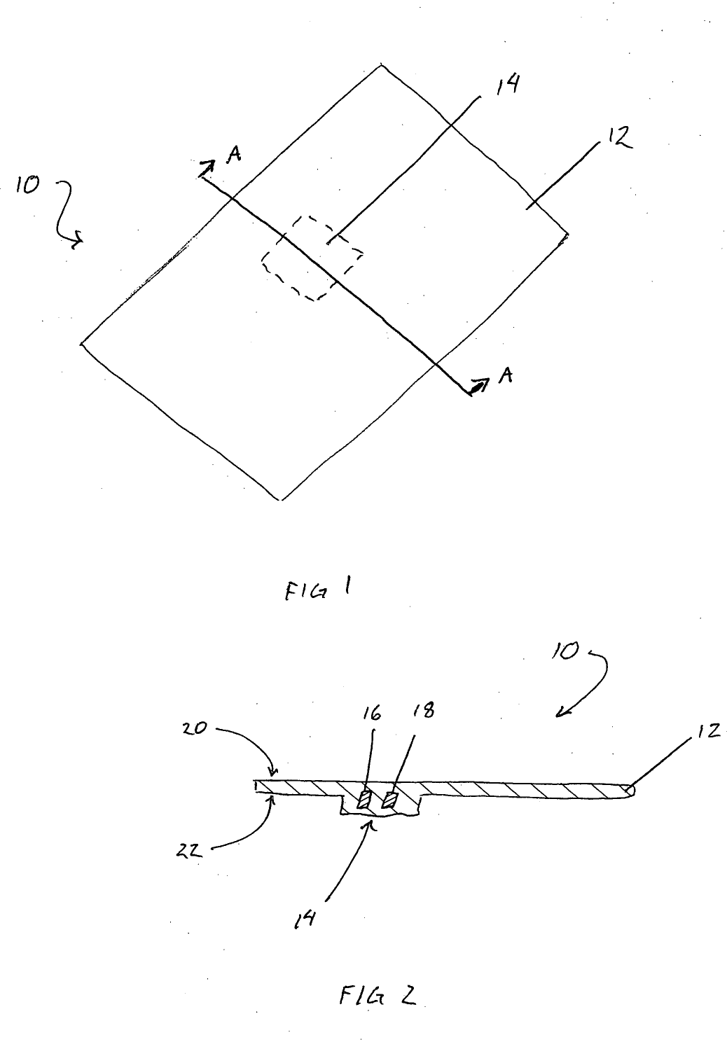

Referring to FIG. 1, a schematic illustration of a vehicle including an under-hood liner 10 consistent with the present invention is shown. The under-hood liner 10 may include a sound reducing structure 12 and an energy absorbing structure 14. The under-hood liner 10 may be shaped generally complimentary to an underside of a vehicle hood. The under-hood liner 10 may be secured to a vehicle hood using any variety of adhesive or mechanical fasteners, such as clips, screws, adhesives, etc. As used herein, the term “sound reducing” is defined as including any material that may absorb, attenuate, insulate or serve as a barrier to sound.

The sound reducing structure 12 of the under-hood liner 10 may be formed from natural fibrous material, synthetic fibrous material, and/or blends thereof. Suitable fibrous materials for providing sound reduction may include, but are not limited to, cotton fiber, glass fiber, polyester fiber, nylon fiber, polyolefin fiber, as well as various other plant, mineral, or polymer-based fibers. According to one embodiment, the sound reducing structure 12 may be a non-woven mat. The fibers of the non-woven mat may be melt-bonded together. In other embodiments, a non-woven mat may be provided including a binder and/or may be needle-punched, etc. to form a generally contiguous member. Those having skill in the art will appreciate that the sound reducing structure 12 may be provided having numerous other structures. For example, the sound reduction structure may be an expanded polymeric foam material, etc. European Patent Specification EP 0 903 623 B1, commonly assigned to the assignee of the present invention discloses such materials and is included herein by reference. Consistent with some embodiments, the sound reducing structure 12 may include a layer of metal foil disposed on a side of the sound reducing structure 12 facing the engine.

In the embodiment depicted in FIG. 1 the energy absorbing structure 14 is shown disposed in a generally central region of the under-hood liner 10. The position of the energy absorbing structure 14 in the under-hood liner 10 may be selected to place the energy absorbing structure 14 overlying an under-hood component that is in close proximity to the underside of the hood. Accordingly, should a pedestrian strike the hood of the vehicle with enough force to cause the hood to deform, the energy absorbing structure 14 may absorb enough of the impact energy to prevent the hood from collapsing far enough to contact the under-hood component in close proximity to the hood. Even if the energy absorbing structure 14 does not prevent the hood from striking an under-hood component, the energy absorbing structure 14 may absorb at least a portion of the impact of the pedestrian striking the hood.

Consistent with the foregoing, the energy absorbing structure 14 may be selectively positioned over an under-hood component that may be less than about 12 inches below the vehicle hood. According to one embodiment, an under-hood liner 10 may be provided having an energy absorbing structure 14 selectively positioned over an under-hood component that is less than about 8 inches below the hood of the vehicle. In further embodiments, the energy absorbing structure 14 may be selectively positioned over an under-hood component that may be between about 2 to about 6 inches below the vehicle hood.

According to a first embodiment, the energy absorbing structure 14 may locally increase the flexural strength of the hood. According to this first embodiment, the force required to deform the hood to strike an under-hood component may be increased. According to another embodiment, the energy absorbing structure 14 may be provided to buckle, crush, or otherwise deform when a pedestrian strikes the vehicle hood and the energy absorbing structure 14 is caused to strike an under-hood component. The deformation of the energy absorbing structure 14 may absorb much of the impact energy of a pedestrian striking the vehicle hood. Accordingly, the hood may be prevented from striking an under-hood component or the force with which the hood strikes an under-hood component may be reduced. According to a still further embodiment, the energy of impact may be absorbed by a combination of flexure and buckling or crushing.

Consistent with either mode of energy absorption, the under-hood liner 10 may include a region having a higher flexural modulus than the remainder of the under-hood liner 10. For example, the under-hood liner 10 may be provided having a flexural. modulus in the region of the energy absorbing structure 14 that may be greater than the flexural modulus of the remaining regions of the under-hood liner 10. According to one embodiment, the flexural modulus of the under-hood liner 10 in the region of the energy absorbing structure 14 may generally be equal to, or greater than, 150,000 psi. In a further embodiment, the flexural modulus of the under-hood liner 10 in the region of the energy absorbing structure 14 may be in the range of between about 150,000 to about 400,000 psi. According to one particular embodiment, the flexural modulus of the under-hood liner 10 in the region of the energy absorbing structure 14 may be in the range of between about 200,000 to about 350,000 psi. According to still a further embodiment, the flexural modulus of the under-hood liner 10 in the region of the energy absorbing structure 14 may be in the range of between about 250,000 to about 350,000 psi.

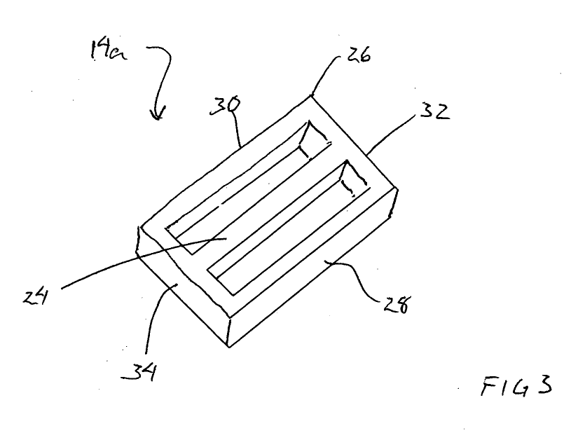

Referring to FIG. 2 a sectional view of the under-hood liner 10 of FIG. 1 is shown. Consistent with the illustrated embodiment, the energy absorbing structure 14 may include a plurality of ribs or longitudinal members 16, 18. In the illustrated embodiment the energy absorbing structure 14, that is, the longitudinal members 16, 18, is surrounded by the sound reducing structure 12. Alternatively, the energy absorbing structure 14 may be disposed on or near a top surface 20 or bottom surface 22 of the sound reducing structure 12. In an embodiment in which the energy absorbing structure 14 is disposed on either the top 20 or bottom 22 surface of the sound reducing structure 12, the energy absorbing structure 14 may be provided integral with or extending at least partially into the sound reducing structure 12. The energy absorbing structure 14 may be provided extending at least partially into the sound reducing structure 12 by pressing the energy absorbing structure 14 into the sound reducing structure 12, by disposing the energy absorbing structure 14 at least partially within corresponding cutouts in the sound reducing structure 12, by forming the sound reducing structure 12 around the energy absorbing structure 14, and by other means known to those skilled in the art. The size, number, shape and spacing of the longitudinal members 16, 18 may be selected depending upon the size of the energy absorbing structure, the desired amount of energy to be absorbed by the energy absorbing structure, etc. Accordingly, the energy absorption characteristics of the energy absorbing structure 14 may be a function of the design and configuration of the energy absorbing structure, as well as the material from which the structure is formed.

The energy absorbing structure 14 of the present invention may be formed from a variety of different materials. According to one embodiment, the energy absorbing structure 14 may be formed from a metallic material. For example, the energy absorbing structure 14 may be formed from steel or aluminum extrusions, stamping, castings, formed mesh, etc. The energy absorbing structure 14 may also be formed from a thermoset or thermoplastic polymeric material. Polymeric materials may be especially advantageous due to the ease of producing an article having a complex shape and due to the variety of mechanical properties available from different polymeric materials. Various polymeric materials may be selected to provide resilience, stiffness, resistance to heat cycling, etc. For example, materials such as polycarbonate (PC), acrylonitrile-butadiene-styrene(ABS), ABS-PC alloys and blends, polyethylene, polypropylene, filled polypropylene, and blends, alloys and combinations thereof, may be used to provide good impact resistance. Various expanded polymeric foam materials, for example polyurethane, polystyrene, polyethylene and polypropylene foams, may also be employed to provide energy absorption. Additionally, an energy absorbing structure 14 herein may be produced from composite materials, including polymeric materials containing various fillers, and further including nano-composite materials. Various techniques, including but not limited to injection molding, insert molding with attachment features, thermoforming, blow molding, extrusion, casting, etc., may be used to produce an energy absorbing structure from a polymeric material. Such forming techniques may be used to not only form the energy absorbing structure 14, but may also form the energy absorbing structure 14 having integrally formed attachment features.

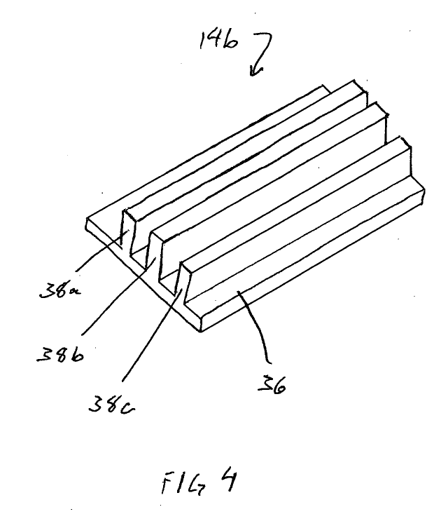

Turning to FIG. 3, another embodiment of an energy absorbing structure 14a according to the present invention is shown. The energy absorbing structure 14a may include one or more ribs or longitudinal members 24. The longitudinal member 24 may be generally surrounded by a frame 26. In the illustrated embodiment, the frame 26 may generally provide a rectangular structure including sides 28, 30 extending generally parallel to the longitudinal member 24 and ends 32, 34 extending generally perpendicular to the longitudinal member 24 and sides 28, 30. The illustrated energy absorbing structure 14a generally provides three parallel longitudinal members 24, 28, 30 maintained in position relative to one another by the ends 32, 34. While the sides 28, 30 and ends 32, 34 are shown generally having the same width and thickness as the longitudinal member 24, it should be understood that other variations are contemplated herein. It should be understood that the embodiment of FIG. 3 may include energy absorbing structures 14a having a shape other than rectangular, such as circular, oval, polygonal, etc. and which particularly conform to the underside of the vehicle hood.

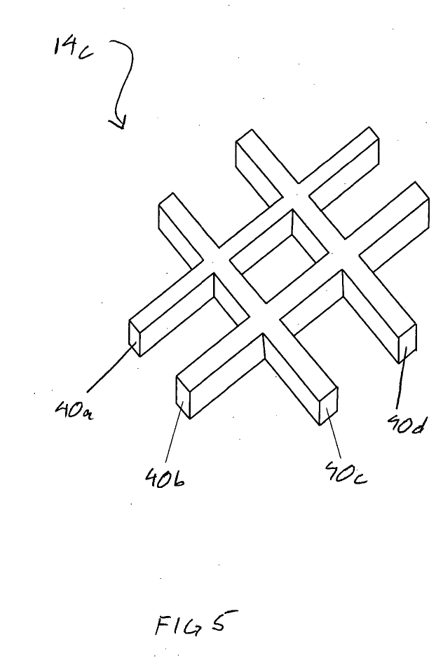

FIG. 4 illustrates another exemplary energy absorbing structure 14b that may suitably be employed with the invention herein. The energy absorbing structure 14b may generally include a base 36 having one or more ribs or fins 38a-c extending from the base 36. Consistent with this embodiment, the base 36 may be provided to retain the ribs 38a-c in a desired orientation relative to one another. As such, the base 36 may be relatively thin, and need not contribute to the energy absorption characteristics of the energy absorbing structure 14b. Even if the base 36 is not provided to contribute to the energy absorption characteristics of the energy absorbing structure 14b, the base 36 may function to attach the energy absorbing structure 14b to the underside of the hood via adhesive means, etc. Alternatively, the base 36 may be designed of a thicker and/or varying cross-section to contribute to the energy absorption characteristics of the energy absorbing structure 14b. In such an embodiment the thickness and profile of the base 36 may be configured accordingly. In a related embodiment, the energy absorbing structure may include a base having one or more ribs extending from each of two opposed faces.

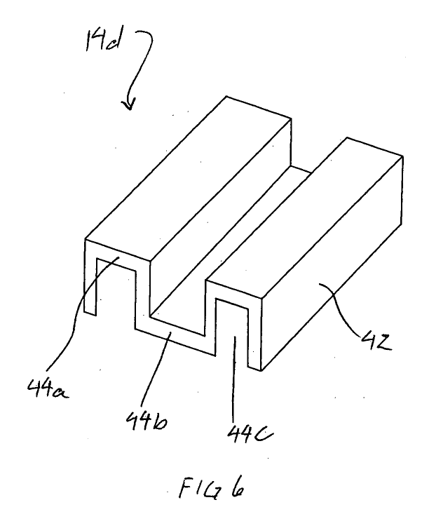

Referring to FIG. 5, yet another embodiment of an energy absorbing structure 14c consistent with the present invention is shown. In contrast to the generally parallel arrangement of longitudinal members illustrated in the preceding embodiments, the energy absorbing structure 14c may include a plurality of ribs or longitudinal members 40a-d generally arranged in a grid or lattice structure. While the illustrated embodiment shows the longitudinal members 40a-d arranged in a regular, orthogonal grid, it should be appreciated that other arrangements including intersecting longitudinal members may suitably be employed, regardless of symmetry or angular relationships. Such structures may, at least in part, be determined by the desired energy absorption characteristics and/or design requirements of the energy absorbing structure 14c and of the under-hood liner 10 in general.

Still another embodiment of an energy absorbing structure 14d is shown in FIG. 6. Consistent with this illustrated embodiment, the energy absorbing structure 14d may include a corrugated panel 42 defining a plurality of alternating parallel channels 44a-c. Consistent with this embodiment, desired energy absorption characteristics may be achieved by varying the width and depth of the alternating channels 44a-c. Additionally, the thickness of the panel 42 may be varied in different areas thereof to further achieve desired energy absorption characteristics.

According to a related embodiment, an energy absorbing structure may be provided including a panel having an egg-crate configuration. Similar to the preceding embodiment, the energy absorption characteristics of the panel may be selected by controlling the height and width of the protrusions and depressions, as well as by controlling the thickness of the panel at various regions thereof.

Various other configurations may also suitably be employed for providing an energy absorbing structure herein. For example, the energy absorbing structure may include a plurality of members extending radially outwardly that may provide a star-burst pattern. In a similar embodiment, one or more of the outwardly extending members may be branched. Additionally, branches or other members may be provided connecting two or more or the outwardly extending members. Further embodiments consistent with the present invention may include patterns of protrusions extending in a direction generally outwardly, either normal or at an angle, from the underside of the hood. The protrusions, which may be cylinders, prisms, cones, pyramids, etc., may emanate from a surface or plate, or may be maintained in a desired location and orientation by being captured by the sound reducing structure.

As mentioned above, an energy absorbing structure consistent with the present invention may generally cushion an impact by increasing the flexural stiffness of at least a region of a vehicle hood, or by buckling or crushing against an under-hood component. Consistent with the first aspect, in order to increase the flexural stiffness of at least a region of a vehicle hood, it may be desirable to secure the energy absorbing structure to the underside of the vehicle hood. By securing the energy absorbing structure to the underside of the vehicle hood, energy tending to deflect the hood may be transferred to the energy absorbing structure. In this manner, energy, for example of a pedestrian striking the hood, may be absorbed or dissipated, or the amount of deflection of the hood resulting from the strike may be reduced. An energy absorbing structure adapted to increase the flexural stiffness of at least a portion of a vehicle hood may be secured to the underside of a vehicle hood using a variety of techniques, including mechanical fasteners, such as screws, rivets, clips, etc., adhesive bonding, etc. According to one embodiment, the energy absorbing structure may be adhesively bonded to the underside of the vehicle hood using a structural adhesive. In one specific embodiment, the energy absorbing structure may be adhesively secured to the underside of the vehicle hood about a majority of a surface of the energy absorbing structure contacting the underside of the hood.

According to another mechanism, the energy absorbing structure may cushion an impact to the hood by buckling and/or crushing, for example against an under-hood component. Consistent with such an embodiment, the energy absorbing structure may include, for example, one or more ribs with a relatively large height to thickness ratio, for example in the range of between about 10:1 to about 50:1, although these height to thickness ratios should not be construed as limiting. In one particular embodiment the ribs had a width of about 1.5 mm and a height of about 30 mm.

In an impact, the impact energy may cause the hood to deflect toward an under-hood component. If the energy absorbing structure contacts the under-hood component, the energy absorbing structure may crush and/or buckle, and may, thereby, absorb energy of the impact and/or reduce an impact force against the under-hood component. According to such an embodiment, it may not be necessary to secure the energy absorbing structure to the underside of the vehicle hood, but only maintain the energy absorbing structure in a generally desired location and orientation with respect to the vehicle hood. Accordingly, an energy absorbing structure according to this aspect may be minimally retained to the sound reducing structure and/or the vehicle hood, for example using mechanical fasteners and/or adhesive, etc.

The various embodiments of energy absorbing structures illustrated and described herein have generally presented a substantially planar configuration. However, it will be appreciated that an energy absorbing structure herein may be provided having a non-planar configuration. Specifically, the configuration of the energy absorbing structure may compliment the shape or contour of the underside of the hood in the region at which the energy absorbing structure is to be located. Similarly, the configuration of the energy absorbing structure may compliment the shape or contour of engine components in the region at which the energy absorbing structure is to be located. Additionally, the features of the energy absorbing structure may vary in different regions of the energy absorbing structure. For example, in an embodiment wherein the energy absorbing structure includes ribs, the thickness and/or height of the ribs may vary along the length of the ribs. Similarly, in an energy absorbing structure including more than one rib, the ribs may have different profiles, widths, thicknesses, etc. Such foregoing variations may be provided based on desired energy absorption characteristics, or may vary to fit specific applications, e.g., provide desired clearances between the under-hood liner and engine components.

Furthermore, as indicated above, various mechanisms may be employed to prevent the hood from striking an under-hood component or to reduce the force with which the hood strikes an under-hood component. The energy absorbing structure may increase the flexural stiffness of a region of the hood corresponding to the location of the energy absorbing structure. The energy absorbing structure may also, or alternatively, buckle, crush, deform, break, etc. thereby absorbing at least a portion of the energy of the impact. The geometry and configuration of the members or features of the energy absorbing structure may be provided consistent with these and other mechanisms. For example, in an embodiment in which the energy absorbing structure includes longitudinal members, the longitudinal members may have a tapered cross-section. The tapered cross-section of the longitudinal members may allow the longitudinal members to crush or buckle under an impact between the vehicle hood and an under-hood component.

Consistent with the foregoing, the under-hood liner may be attached to the vehicle in a number of ways to facilitate different energy absorption mechanisms. For example, if the energy absorbing structure is directed at increasing the flexural strength of a region of the hood, it may be desirable to securely attach at least a portion of the energy absorbing structure to the underside of the hood. To this end, the energy absorbing structure may be adhesively attached to the under-side of the hood, and/or may be attached using various mechanical fasteners. If, however, the energy absorbing structure is provided to absorb at least a portion of the impact energy by buckling, etc., or by compressing the energy absorbing structure between the hood and an under-engine component, it may not be necessary to attach the energy absorbing structure itself to the underside of the hood. Rather, in such an embodiment, the sound reducing structure may be attached to the hood and the energy absorbing structure may be maintained generally in a desired position or location under the hood by the sound reducing structure.

FIGS. 1 and 2 herein illustrate the energy absorbing structure 14 included as only a portion of the under-hood liner 10. However, it should be understood that the energy absorbing structure may be coextensive with any portion of an under-hood liner consistent with the present invention. As such, the energy absorbing structure may be entirely coextensive with an under-hood liner herein. Furthermore, the energy absorbing structure may extend beyond at least a portion of the sound reduction structure. Consistent with this last aspect, at least a portion of the energy absorbing structure may extend beyond the sound reduction structure and include mounting or securement features for retaining the under-hood liner to the under side of the vehicle hood such that it accomplishes it's purpose to provide impact protection for a pedestrian.

The illustrated embodiments of an energy absorbing structure have generally depicted the energy absorbing structure -to include a relatively small number of elements, such as ribs or longitudinal members. It should be understood that the illustrated embodiments herein are set forth to provide some examples of suitable structural arrangements. The number, size and positioning of any elements making up the energy absorbing structure herein may be varied to suit different design considerations, including but not limited to, energy absorption characteristics, size, weight, material from which the structure is formed, etc.

In use, the under-hood liner consistent with the present invention may not only reduce observed noise generated by a vehicle engine and/or other auxiliary under-hood components, the under-hood liner may also provide energy absorption in the case of an impact with a pedestrian, which energy absorption may reduce the impact experienced by the pedestrian. Specifically, the under-hood liner herein may absorb at least some of the energy of a pedestrian striking the hood of the vehicle. In a situation in which a pedestrian strikes the hood of a vehicle in an accident, the hood may deform to such an extent that the hood may contact an under-hood component, such as an engine component. A pedestrian striking the hood and causing such deformation of the hood may strike the under-hood component through the hood of the vehicle. Such impacts may cause additional injury to the pedestrian, especially if the under-hood component contacted is unyielding, or the portion contacted includes a hard corner or sharp edge. According to one embodiment, the under-hood liner may be provided, in part, to absorb the energy of a pedestrian striking the hood of the vehicle in an accident and to prevent the hood from coming into contact with under-hood components, such as engine components, etc, or to reduce the force of a contact between the hood and an under-hood component.

It should be understood that the various embodiments illustrated and described herein are capable of being combined with one another. Additionally, the specific embodiments herein are set forth for the purpose of illustration only, and should not be construed as limiting. Accordingly, the present invention should only be limited by the claims appended hereto.

1. A liner for a vehicle hood, said liner comprising:
a sound reducing structure, and an energy absorbing structure.

2. A liner according to claim 1 wherein said energy absorbing structure is selectively positioned over an under-hood component proximate said vehicle hood.

3. A liner according to claim 2 wherein said energy absorbing structure is selectively positioned over an under-hood component, said component being less than about 12 inches from said vehicle hood.

4. A liner according to claim 2 wherein said energy absorbing structure is selectively positioned over an under-hood component, said component being less than about 8 inches from said vehicle hood.

5. A liner according to claim 2 wherein said energy absorbing structure is selectively positioned over an under-hood component, said component being between about 2 and about 6 inches from said vehicle hood.

6. A liner according to claim 1 wherein said energy absorbing structure is at least partially disposed in said sound reducing structure.

7. A liner according to claim 1 wherein said energy absorbing structure is completely surrounded by said sound reducing structure.

8. A liner according to claim 1 wherein said sound reducing structure comprises a fibrous material.

9. A liner according to claim 1 wherein said energy absorbing structure comprises a plurality of longitudinal members.

10. A liner according to claim 9 wherein said plurality of longitudinal members are arranged in a lattice structure.

11. A liner according to claim 9 wherein said plurality of longitudinal members are surrounded by a frame.

12. A liner according to claim 1 wherein said energy absorbing structure comprises a base and at least one rib extending from said base.

13. A liner according to claim 1 wherein said energy absorbing structure comprises a panel having a plurality of alternating channels.

14. A liner according to claim 1 wherein said energy absorbing structure comprises a metallic material.

15. A liner according to claim 1 wherein said energy absorbing structure comprises a polymeric material.

16. A liner according to claim 15 wherein said polymeric material has a flexural modulus of between about 150,000 psi to about 400,000 psi.

17. A liner according to claim 15 wherein said polymeric material has a flexural modulus of between about 250,000 psi to about 350,000 psi.

18. A liner according to claim 1 wherein said energy absorbing structure absorbs energy by bending.

19. A liner according to claim 18 wherein sound reducing structure has a first flexural modulus and said energy absorbing structure has a second flexural modulus greater than said first flexural modulus.

20. A liner according to claim 19 wherein said energy absorbing structure has a modulus greater than about 150,000 psi.

21. A liner according to claim 19 wherein said energy absorbing structure has a modulus of between about 200,000 psi to about 350,000 psi.

22. A liner according to claim 1 wherein said energy absorbing structure absorbs energy by buckling.

23. A liner according to claim 1 wherein said energy absorbing structure absorbs energy by crushing.

24. A liner for the underside of a vehicle hood comprising:
a sound reducing material; and
at least one longitudinal member, said at least one longitudinal member at least partially disposed in said sound reducing material.

25. A liner according to claim 24 wherein said sound reducing material comprises a fibrous material.

26. A liner according to claim 24 wherein said at least one longitudinal member comprises a plurality of longitudinal members.

27. A liner according to claim 26 wherein said plurality of longitudinal member comprise intersecting longitudinal members.

28. A liner according to claim 27 wherein said intersecting longitudinal members comprise a lattice.

29. A liner for a vehicle hood comprising:
a fibrous body; and
an energy absorbing structure.

30. A liner according to claim 29 wherein said energy absorbing structure is at least partially disposed in said fibrous body.

31. A liner according to claim 29 wherein said energy absorbing structure comprises a plurality of longitudinal members.

32. A liner according to claim 31 wherein said longitudinal members extend from a base member.

33. A liner according to claim 29 wherein said energy absorbing structure comprises a 1 5 plurality of alternating channels.

34. A liner according to claim 29 wherein said energy absorbing structure comprises a polymeric material.

35. A liner according to claim 29 wherein said energy absorbing structure comprises a metallic material.

36. A liner according to claim 29 wherein said fibrous body comprises polymeric fibers.

37. A liner according to claim 29 wherein said fibrous body comprises mineral based fibers.

38. A liner according to claim 29 wherein said energy absorbing structure absorbs energy by bending.

39. A liner according to claim 29 wherein said energy absorbing structure absorbs energy by buckling.

40. A liner according to claim 29 wherein said energy absorbing structure absorbs energy by crushing.
